(19) United States
(12) Patent Application Publication
(10) Pub. No.: US 2011/0171440 A1
(43) Pub. Date: Jul. 14, 2011

(54) DECORATIVE FILM AND IN MODE DECORATION/FORMING PROCESS

(75) Inventors: YUNG-HSIUNG CHENG, TAOYUAN COUNTY (TW); CHAO-YING LIN, TAIPEI COUNTY (TW); JEN-HUAI CHANG, TAOYUAN COUNTY (TW)

(73) Assignee: ENTIRE TECHNOLOGY CO., LTD., TAOYUAN COUNTY (TW)

(21) Appl. No.: 12/687,432

(22) Filed: Jan. 14, 2010

(51) Int. Cl. B32B 7/02; B32B 38/00

(52) U.S. Cl. 428/212; 156/163

(57) ABSTRACT

A decorative film is provided. The decorative film comprises: a plastic substrate, comprising a surface, and a plurality of optical film layers, being formed by laminating optical film layers of at least two different materials onto the surface, wherein each of the optical film layers and another optical film layer are stretched in at least one direction to create a difference in refractive indices of no less than 0.1 between the optical film layers.

### BACKGROUND OF THE INVENTION

1. Field of the Invention

The present invention relates to a decorative film and an In Mode Decoration/Forming (IMD) process, and more particularly, to an IMD process that enables colors to change associated with viewing angles by virtue of a difference in refractive indices of different layers within a plurality of optical film layers and a decorative film thereof.

2. Description of Related Art

The In Mold Decoration/Forming (IMD) technology has now been developed and widely applied in projects of modifying plastic surfaces. Nowadays, the IMD technology has found wide application in exterior parts of electronic products, household appliances, automobiles and the like. The IMD technology may be subdivided into IMR, IML, IMF and etc., and mainly comprises three processes, i.e., printing, forming and molding. However, when the conventional IMD technology is employed to fabricate a mirror with a sparkling enclosure or to deliver a color conversion effect, one or more layers of metallic or pigment coatings must be coated on a surface of a substrate. If an effect of changing colors associated with viewing angles is desired, multi-layer vapor deposition will be further needed. Unfortunately, such a process is costly and the metallic coatings exhibit poor ductibility, which leads to a low yield rate of the IMD process and makes it impossible to improve quality of the overall product.

A conventional multi-layer optical film is an optical component which allows light of a certain wavelength band to transmit therethrough but reflects light of other wavelength bands. U.S. Pat. No. 3,610,729 proposed a multi-layer optical film formed by laminating two kinds of optical layers together, where the two kinds of optical layers are made of polymers of different refractive indices. Difference in refractive indices of the two different polymers can lead to constructive interference of incident light. Thereby, the multi-layer optical film can allow light of a specific wavelength to transmit therethrough but reflect light of other wavelengths.

Generally speaking, optical layers of a multi-layer optical film are in form of a quarter wave stack. By the quarter wave stack, it means that, each of the optical layers is of a thickness equal to a quarter of a wavelength to which the optical layer corresponds. Here, the optical thickness is a product of a thickness of the optical layer and a refractive index thereof.

U.S. Pat. No. 5,976,424 proposed a method of producing a multi-layer optical film, the production process of which is as follows: firstly, a first resin and a second resin are provided; then, the first resin and the second resin are extruded into a resin stream, which comprises a plurality of layers and has a first major surface and a second major surface, wherein at least some of the plurality of layers comprises the first resin while at least some other of the plurality of layers comprises the second resin, and wherein the number of layers having a thickness of less than k microns (μm) and disposed within 400 μm in depth of the first major surface is m, and the number of layers having a thickness of less than k μm and disposed within 400 μm in depth of the second major surface is n, where m>n, k≦10; further, the resin stream is casted against a casting surface so that the first major surface is in contact with the casting surface.

Accordingly, in view of the shortcomings of the aforesaid multi-layer vapor deposition process and the metallic coating films, the present inventor has made great efforts to impart a sparkling appearance and an effect of changing colors associated with viewing angles to an IMD product through applications of the design principles of multi-layer optical films.

### SUMMARY OF THE INVENTION

A primary objective of the present invention is to provide a decorative film and an In Mode Decoration/Forming (IMD) process. With superior formability, the decorative film is very suitable for use in an IMD process without the problem of cracking; on the other hand, a difference in refractive indices exists in at least one direction between the film layers made of different materials of the decorative film, which imparts a particular quality to a final product with sparkling colors in appearance in accordance with an effect of changing colors associated with different viewing angles.

To achieve the above-mentioned objectives, the present invention provides a decorative film, comprising: a plastic substrate, comprising a surface; a plurality of optical film layers, formed by laminating optical film layers of at least two different materials onto the surface, wherein each of the optical film layers and another optical film layer are stretched in at least one direction to create a difference in refractive indices of no less than 0.1 between the optical film layers.

To achieve the above-mentioned objectives, the present invention also provides an In Mode Decoration/Forming (IMD) process, comprising the following steps of: step 1: providing a plastic substrate having an upper surface and a lower surface, a plurality of optical film layers made of at least two different materials, a skin layer and a plastic material; step 2: laminating the plurality of optical film layers made of the at least two different materials onto the upper surface, wherein each of the optical film layers and another optical film layer are stretched in at least one direction to create a difference in refractive indices of no less than 0.1 between the optical film layers; step 3: attaching the skin layer onto the upper surface of the plurality of optical film layers to form a decorative film; step 4: forming the decorative film into a predetermined shape; and step 5: injection molding the plastic material onto the lower surface of the decorative film of the predetermined shape.

### BRIEF DESCRIPTION OF THE DRAWINGS

FIG. 1 is a flowchart of a first embodiment of an IMD process applying a decorative film according to the present invention;

FIG. 2 is a flowchart of a second embodiment of the IMD process applying a decorative film according to the present invention;

FIGS. 3 to 3B are schematic views illustrating the IMD process applying a decorative film according to the present invention;

FIG. 4 illustrates a reflectance spectrum of a first product fabricated by the IMD process applying a decorative film according to the present invention;

FIG. 5 illustrates a reflectance spectrum of a second product fabricated by the IMD process applying a decorative film according to the present invention;

FIG. 6 illustrates a reflectance spectrum of a third product fabricated by the IMD process applying a decorative film according to the present invention; and

FIG. 7 is a schematic view of a bowing region according to the present invention.

### DETAILED DESCRIPTION OF THE PREFERRED EMBODIMENTS

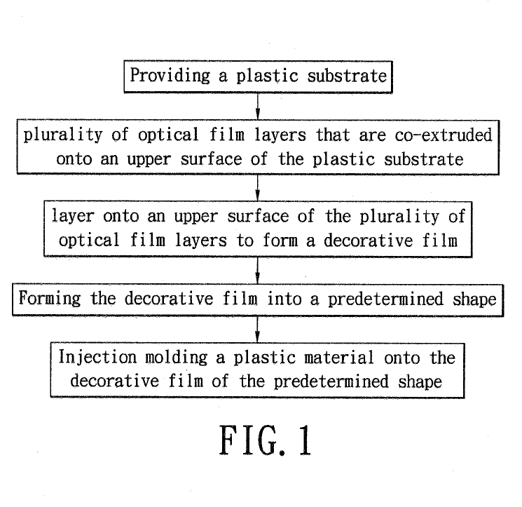

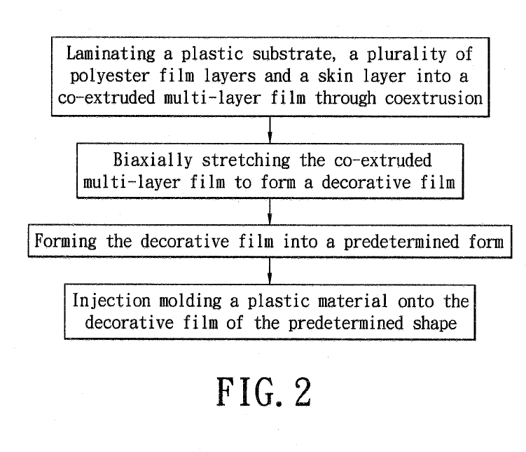

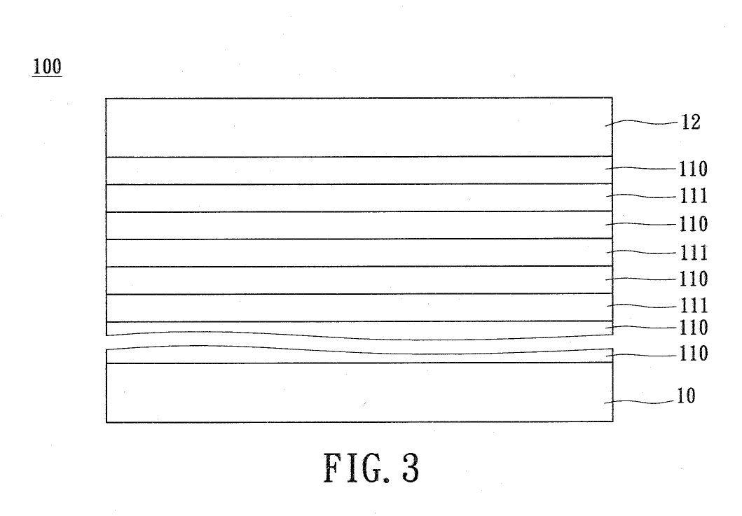

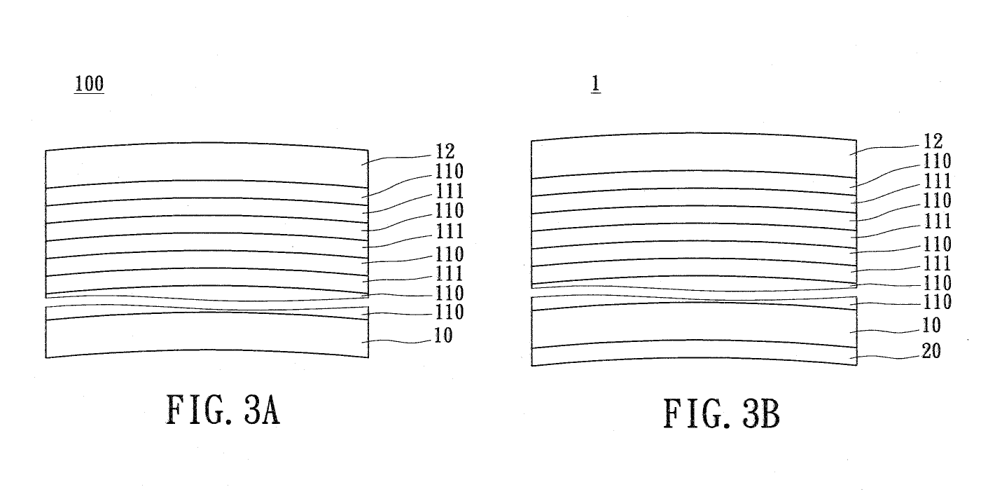

Referring now to FIGS. 1 and 2, the present invention provides a decorative film and an In Mode Decoration/Forming (IMD) process. By applying a plurality of optical film layers having differences in refractive indices and exhibiting superior formability to enclosures of electronic products such as cell phones, the IMD process imparts to the enclosures of electronic products an effect of changing colors with different viewing angles or a specular reflection effect. Through the following embodiments, the present invention can apply the plurality of optical film layers to the IMD process. The first embodiment comprises the following steps of (referring to FIGS. 3 to 3B together):

Step 1: a plastic substrate 10 having an upper surface and a lower surface, a plurality of optical film layers made of at least two different materials (i.e., the first resin film layers 110 and the second resin film layers 111), a skin layer 12 and a plastic material 20 are provided. The plastic substrate 10 is primarily an optical film with good formability, and is made of, for example but not limited to, polyethylene terephthalate (PET), polycarbonate (PC), tri-acetyl cellulose (TAC), polymethylmethacrylate (PMMA), methylmethacrylate styrene (MS) or cyclic olefin copolymer (COC). Additionally, in embodiments of the present invention, thickness of the plastic substrate 10 may be adjusted depending on different applications.

Step 2: the plurality of optical film layers is laminated onto the upper surface of the plastic substrate 10. The plurality of optical film layers are formed by laminating two or more kinds of materials together (e.g., the first resin film layers 110 and the second resin film layers 111 shown in FIG. 3), and the material is selected from PET, polyethylene naphthalate (PEN), PMMA or the like. Each of the optical film layers and another optical film layer are stretched in at least one direction to create a difference in refractive indices of no less than 0.1 between the optical film layers. In this step, an ultraviolet (UV) curable adhesive is used to attach the plurality of optical film layers onto the upper surface of the plastic substrate 10, although the present invention is not merely limited thereto.

The plurality of optical film layers are fabricated through the following steps.

Step A: the aforesaid two or more kinds of polyester materials are coextruded into a plurality of polyester film layers that are alternately arranged; and step B: the plurality of polyester film layers are axially (uniaxially or biaxially) stretched to create a predetermined difference in refractive indices in at least one direction between the optical film layers made of different polyester materials. The difference in refractive indices is no less than 0.1, and most preferably is 0.29, and this can lead to constructive interference of incident light. Thereby, the plurality of optical film layers can allow light of a specific wavelength to transmit therethrough but reflect light of other wavelengths. As a result, by means of these optical film layers, a sparkling appearance and an effect of changing colors with different viewing angles can be obtained.

However, to impart formability to the plurality of optical film layers to make them more suitable for the IMD process, the plurality of optical film layers may, upon being stretched, be introduced into a cooling zone to be cooled at a cooling temperature of 60° C. to 120° C. for 1 second (s) to 5 s and then subjected to a heat setting treatment to impart good formability to the plurality of optical film layers. It shows properties and formability of the plurality of optical film layers after being stretched using different stretching process parameters, wherein the plurality of optical film layers are characterized in that:

1. After being subjected to a heat setting treatment at a temperature of 150° C. for 30 min, the plurality of optical film layers exhibit a ratio of machine direction (MD) shrinkage to transverse direction (TD) shrinkage of 0.8 to 1.2. This characteristic of the plurality of optical film layers is an important indicator of formability. By using the process of the present invention, the ratio of MD shrinkage to TD shrinkage of the plurality of optical film layers may be controlled to be from 0.8 to 1.2, i.e., shrinkages in the two directions are very close to each other. As a result, after the thermal forming step (e.g., injection molding at a high temperature and under a high pressure), dimensions of the plurality of optical film layers will not vary greatly in the two directions; in other words, after the injection molding, dimensions of the plurality of optical film layers in the MD direction and the TD direction are very close to each other, which helps to improve formability of the plurality of optical film layers greatly.

2. The plurality of optical film layers has a bowing region of no greater than 1.5%. The bowing region is calculated according to Equation 1 as follows:

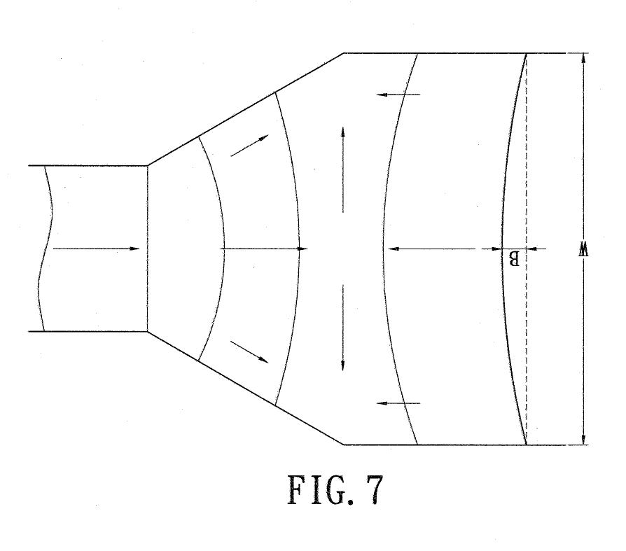

Bowing region=(B/W)×100%, Equation 1

where W is a width in the transverse direction, and B is a maximum depression depth. Referring to FIG. 7, when the plurality of optical film layers is stretched in the transverse direction, a bowing region will occur, which can be calculated according to Equation 1 described above. By use of the cooling zone, the bowing region can be controlled to be no greater than 1.5% and, after being stretched in the transverse direction, the plurality of optical film layers can keep regions thereof in parallel along the transverse direction, which also results in very uniform thermal properties and a high orientation degree of the plurality of optical film layers. On the other hand, decreasing the calculated value of the bowing region may also result in preferable thermal shrinkage performance of the plurality of optical film layers. For example, the ratio of MD shrinkage to TD shrinkage of the plurality of optical film layers ranges between 0.8 and 1.2, and most preferably between 0.9 and 1.1; the plurality of optical film layers exhibits a shrinkage of ≦8% after being treated at 150° C. for 30 min; and the bowing region, which is calculated according to Equation 1, is most preferably ≦1.5%. A well-controlled bowing region is also an important indicator of uniformity in appearance hue of the plurality of optical film layers, and in case the bowing region exceeds 1.5%, nonuniform hue would occur to the appearance of the plurality of optical film layers, causing loss of benefits of using the plurality of optical film layers. In other words, the plurality of optical film layers is stretched in at least one direction to create a difference in refractive indices between the individual optical film layers.

Step 3: a skin layer 12 is attached onto the upper surface of the plurality of optical film layers to form a decorative film 100 with formability (as shown in FIG. 3). The skin layer 12 is primarily made of a hard material to provide good protection capability. The skin layer 12 has a predetermined surface hardness which, in this embodiment, is at least H. In another embodiment, the plastic substrate 10, the plurality of optical film layers and the skin layer 12 may be formed integrally through coextrusion.

Step 4: the decorative film 100 with formability is formed into a predetermined shape, as shown in FIG. 3B. In this step, the decorative film 100 with ductibility (i.e., formability) is formed into a predetermined outline, i.e., is bent into a desired shape of the final product. For example, through a process such as baking at a high pressure or vacuum molding, the decorative film 100 with ductibility is formed into an enclosure having a predetermined shape and appearance such as a cell phone enclosure. The plurality of ductile optical film layers with superior formability are used in the IMD process of the present invention. Even though the enclosure is deformed under action of an external force, the plurality of optical film layers can still be attached on the plastic substrate 10 by virtue of the ductibility thereof without cracking or other structural damages.

Step (5): a plastic material 20 is formed and attached onto the lower surface of the plastic substrate 10 of the decorative film 100, which has been formed into the predetermined shape, to produce an IMD product 1, as shown in FIG. 3B. That is, the decorative film formed as described above is put into an injection mold, and then an ABS injection molding is performed on the lower surface of the plastic substrate 10 of the decorative film to obtain a final product (i.e., the plastic material 20); and then the injection molded ABS plastic material is attached onto the lower surface of the plastic substrate 10 of the decorative film 100. The plastic material 20 may be polycarbonate (PC), polypropylene (PP), polystyrene (PS), polymethylmethacrylate (PMMA), methylmethacrylate styrene (MS), acrylonitrile butadiene styrene (ABS), polyethylene terephthalate (PET), polyoxymethylene (POM), or nylon, although it is not merely limited thereto.

According to the above embodiment, the plurality of optical film layers with superior formability and having difference in refractive indices between different film layers is applied, through attachment, to the IMD process to produce a product that has an effect of changing colors with different viewing angles; and the plastic substrate 10, the plurality of optical film layers and the skin layer 12 are attached together to produce the decorative film 100.

Additionally, the present invention further provides another embodiment of the IMD process that uses the decorative film 100. The IMD process of the second embodiment differs from the first embodiment in that, the aforesaid attachment step is replaced by a coextrusion process in the second embodiment. This IMD process comprises the following steps of (referring back to FIG. 2 and FIGS. 3 through 3B):

Step 1: a plastic substrate 10, a plurality of polyester films made of two or more kinds of polyester materials and a skin layer 12 are laminated, through coextrusion, into an extruded multi-layer film. In this step, instead of the attachment step in the above embodiment, materials of the individual film layers are coextruded into one piece, wherein the plastic substrate 10 has good formability.

Step 2: the coextruded multi-layer film is then axially (uniaxially or biaxially) stretched to form a decorative film 100 with formability (as shown in FIG. 3). After being axially stretched, the plurality of optical film layers consisting of multiple layers of polyester films exhibits a predetermined difference in refractive indices, and the predetermined surface hardness of the skin layer 1 may be improved to at least 2H after being stretched. In this step, the plastic substrate 10, the plurality of optical film layers made of two or more kinds of polyester materials which are arranged alternately, and the skin layer 12 are axially stretched to impart superior formability and ductibility to the plurality of optical film layers and to create a difference in refractive indices between different layers of the plurality of optical film layers, thereby resulting in an optical effect. Properties of the plurality of optical film layers are identical to those of the first embodiment and, thus, will not be further described herein.

Step 3: the decorative film 100 with formability is formed into a predetermined shape, as shown in FIG. 3A.

Step 4: forming and attaching a plastic material 20 onto the lower surface of the plastic substrate 10 of the decorative film 100 with the predetermined shape, as shown in FIG. 3B.

Steps 3 and 4 described herein are the same as steps 4 and 5 of the first embodiment and, thus, will not be further described herein.

Next, the present invention will utilize the two embodiments described above to fabricate an IMD product 1.

First Experiment Group:

Initially, the present invention can utilize the first embodiment to fabricate an enclosure having a mirror effect (i.e., a first product).

Step 1: a plastic substrate 10 made of polycarbonate is provided.

Step 2: a plurality of optical film layers are attached onto an upper surface of the plastic substrate 10. In this step, a UV curable adhesive is used to attach the plurality of optical film layers onto the plastic substrate 10 made of polycarbonate. Here, with a total thickness of 260 micrometers (μm), the plurality of optical film layers includes 302 layers of PEN (i.e., the first film layers 110) and PMMA (i.e., the second film layers 111) that are formed through coextrusion and laminated alternately. Then the plurality of optical film layers is biaxially stretched, either being stretched in the machine direction (MD) and the transverse direction (TD) by 2.8 times and 3.5 times individually or being stretched in both directions by 3.0 times simultaneously. After being stretched, the PEN film layers and the PMMA film layers exhibit therebetween a difference in refractive indices of approximately 0.26 and a ratio of extruded thickness of 1/1.165, which represents a gradient variation in thickness.

Step 3: the skin layer 12 made of PMMA is attached onto an upper surface of the plurality of optical film layers. The skin layer 12 made of PMMA is of a high hardness to provide a satisfactory protection capability. Then, subsequent forming and molding processes are performed to complete the enclosure of the electronic product.

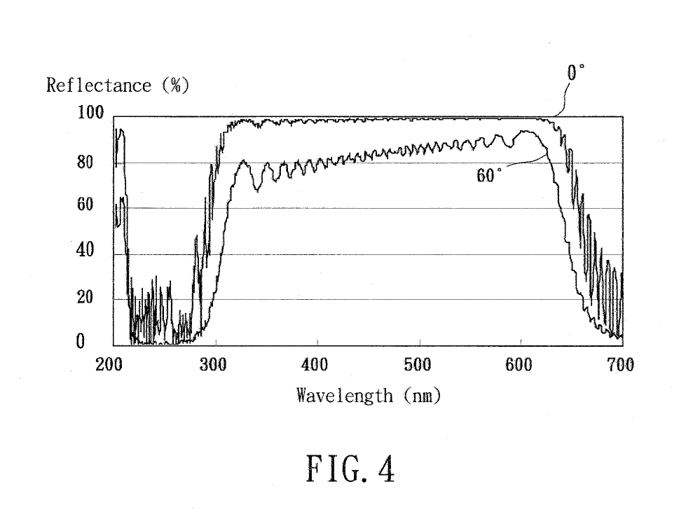

Next, the second embodiment is utilized to fabricate an enclosure having a mirror effect as follows. A 1050 μm thick decorative film having 304 layers is produced, through coextrusion, from a plastic substrate 10 made of polycarbonate, PEN materials and PMMA materials, and a skin layer 12 made of PMMA, in which the skin layer 12 made of PMMA is 40 μm in thickness and the plastic substrate 10 made of polycarbonate is 750 μm in thickness. The skin layer 12 used in this experiment group is made of a modified PMMA material which, through the aforesaid stretching and orientation, may get a hardness of at least 2H to effectively improve the protection capability. FIG. 4 shows a reflectance spectrum of this product. As shown in FIG. 4, the reflection band thereof falls within the visible light region, so the product presents a mirror appearance that is totally reflective at a front viewing angle of 0°, and as the viewing angle becomes larger, the reflection band shifts towards the shorter wavelength bands. For example, at a viewing angle of 60°, the product presents a light blue color.

Second Experiment Group:

The present invention can utilize the first embodiment to produce an enclosure having a color-changing effect (i.e., a second product). In this experiment group, 218 layers of PMMA (i.e., the first film layers 110) and COPEN (i.e., the second film layers 111) that are laminated alternately are coextruded to form a plurality of optical film layers of 220 μm in thickness. The plurality of optical film layers is further biaxially stretched, either being stretched in the machine direction (MD) and the transverse direction (TD) by 3.0 times and 3.7 times individually or being stretched in both directions by 3.2 times simultaneously. Then the plurality of optical film layers is attached onto the plastic substrate 10 and, meanwhile, the skin layer 12 is attached onto the plurality of optical film layers for purpose of protection.

For this experiment group, the second embodiment may also be utilized to co-extrude the plastic substrate 10, the COPEN material and the PMMA material, and the skin layer 12 into a decorative film 100 comprising 220 layers, and then subsequent steps such as axial stretching, forming and molding are performed to produce the IMD product 1 having a color-changing effect.

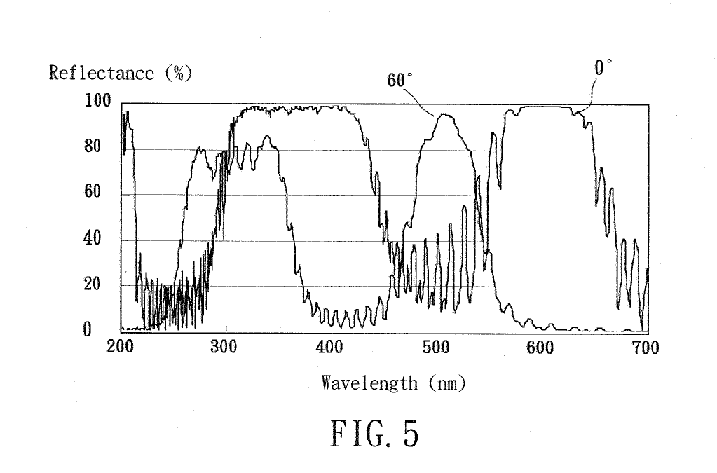

FIG. 5 shows a reflectance spectrum of this product. As shown in FIG. 5, the reflection band thereof falls within the visible light region, so the product presents a pale yellow color at a front viewing angle of 0°, and as the viewing angle becomes larger, the reflection band shifts towards the shorter wavelength bands. For example, at a viewing angle of 60°, the product presents an orange color, which means that the appearance color of the product changes with viewing angles.

Third Experiment Group:

The present invention can utilize the first embodiment to produce an enclosure having a color-changing effect (i.e., a third product). In this experiment group, 247 layers of PMMA (i.e., the first resin film layers 110) and COPEN (i.e., the second resin film layers 111) that are laminated alternately are coextruded to form a plurality of optical film layers of 230 μm in thickness. The plurality of optical film layers is further biaxially stretched, either being stretched in the machine direction (MD) and the transverse direction (TD) by 3.0 times and 3.7 times individually or being stretched in both directions by 3.2 times simultaneously. Then the plurality of optical film layers is attached onto the plastic substrate 10 and, meanwhile, the skin layer 12 is attached onto the plurality of optical film layers for purpose of protection.

For this experiment group, the second embodiment may also be utilized to co-extrude the plastic substrate 10, the plurality of optical film layers made of COPEN and PMMA, and the skin layer 12 into a decorative film 100 comprising 249 layers, and then subsequent steps such as axial stretching, forming and molding are performed to fabricate the final product.

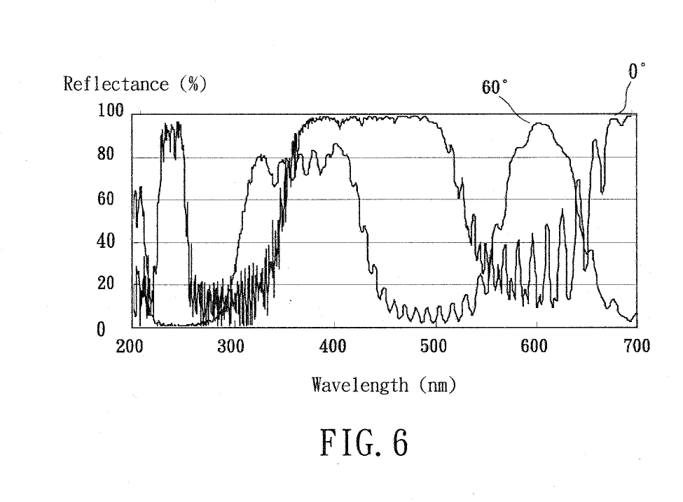

FIG. 6 shows a reflectance spectrum of this product. As shown in FIG. 6, the reflection band thereof falls within the visible light region, so the product presents a light blue color at a front viewing angle of 0°, and as the viewing angle becomes larger, the reflection band shifts towards the shorter wavelength bands. For example, at a viewing angle of 60°, the product presents a green color, which means that the product has a sparkling color-changing effect. In this experiment group, the difference in refractive indices of the plurality of optical film layers is at least 0.17, and most preferably 0.29.

The present invention further discloses an IMD product 1, comprising: a plastic material 20; and a decorative film 100 with formability disposed on the plastic material 20. The decorative film 10 0 comprises: a plastic substrate 10; a plurality of optical film layers disposed on the plastic substrate 10, being formed by laminating two or more kinds of polyester materials together, wherein a predetermined difference in refractive indices exists between the film layers of different polyester materials; and a skin layer 12 disposed on the plurality of optical film layers. Properties of the plurality of optical film layers have already been described in the aforesaid process steps and, thus, will not be further described herein.

What is claimed is:

1. A decorative film, comprising:
a plastic substrate comprising a surface; and
a plurality of optical film layers, being formed by laminating optical film layers of at least two different materials onto the surface, wherein each of the optical film layers and another optical film layer are stretched in at least one direction to create a difference in refractive indices of no less than 0.1 between the optical film layers.

2. The decorative film according to claim 1, wherein a skin layer having a surface hardness of no less than H is disposed on the plurality of optical film layers.

3. The decorative film according to claim 1, wherein the plastic substrate is made of polyethylene terephthalate (PET), polycarbonate (PC), tri-acetyl cellulose (TAC), polymethylmethacrylate (PMMA), methylmethacrylate styrene (MS) or cyclic olefin copolymer (COC).

4. An In Mold Decoration/Forming (IMD) process, comprising the following steps of:
step 1: providing a plastic substrate having an upper surface and a lower surface, a plurality of optical film layers made of at least two different materials, a skin layer and a plastic material;
step 2: laminating the plurality of optical film layers made of the at least two different materials onto the upper surface of the plastic substrate, wherein each of the optical film layers and another optical film layer are stretched in at least one direction to create a difference in refractive indices of no less than 0.1 between the optical film layers;
step 3: attaching the skin layer onto the upper surface of the plurality of optical film layers to form a decorative film;
step 4: forming the decorative film into a predetermined shape; and
step 5: injection molding the plastic material onto the lower surface of the decorative film of the predetermined shape.

5. The IMD process according to claim 4, wherein the plastic substrate is made of polyethylene terephthalate (PET), polycarbonate (PC), tri-acetyl cellulose (TAC), polymethylmethacrylate (PMMA), methylmethacrylate styrene (MS) or cyclic olefin copolymer (COC).

6. The IMD process according to claim 4, wherein, in the step 2, an ultraviolet (UV) curable adhesive is used to attach the plurality of optical film layers onto the upper surface of the plastic substrate.

7. The IMD process according to claim 4, wherein the plastic substrate, the plurality of optical film layers and the skin layer are integrally formed through co-extrusion.

8. The IMD process according to claim 4, wherein the skin layer has a surface hardness of at least H.

9. The IMD process according to claim 4, wherein the step 2 further comprises: stretching the plurality of optical film layers at a temperature of 150° C. in a machine direction (MD) and a transverse direction (TD) to obtain a shrinkage rate ranging from 0.8 to 1.2 of the plurality of optical film layers.

10. The IMD process according to claim 4, wherein, in the step 4, the decorative film is formed into the predetermined shape through baking at a high pressure or vacuum molding.
